(19) United States
(12) Patent Application Publication
(10) Pub. No.: US 2012/0050518 A1
(43) Pub. Date: Mar. 1, 2012

(54) INSPECTING APPARATUS AND INSPECTION METHOD

(75) Inventor: Masahiro Miyata, Oita-shi (JP)

(73) Assignee: KABUSHIKI KAISHA TOSHIBA, Tokyo (JP)

(21) Appl. No.: 13/053,403

(22) Filed: Mar. 22, 2011

(30) Foreign Application Priority Data
Aug. 27, 2010 (JP) 2010-191008

(51) Int. Cl. H04N 7/18

(52) U.S. Cl. 348/79; 348/E07.085

(57) ABSTRACT

An inspecting apparatus includes a first light receiving sensor that senses an image of a surface of the wafer incident from the microscope, and that acquires first inspection image data of the surface of the wafer. The inspecting apparatus includes a second light receiving sensor that corrects a focusing position to focus on a reference position of an upper portion of a bump formed on the surface of the wafer, with respect to an image incident from the microscope, that senses an image of the bump incident from the microscope, and that acquires second inspection image data of the bump. The inspecting apparatus includes a first image processing unit that compares the first inspection image data acquired by the first light receiving sensor with previously acquired first reference image data, and that detects a defect of the surface of the wafer on the basis of the comparison result. The inspecting apparatus includes a second image processing unit that compares the second inspection image data acquired by the second light receiving sensor with previously acquired second reference image data, and that detects a defect of the bump on the basis of the comparison result.

### CROSS-REFERENCE TO RELATED APPLICATION

This application is based upon and claims the benefit of priority from the prior Japanese Patent Application No. 2010-191008, filed on Aug. 27, 2010, the entire contents of which are incorporated herein by reference.

### BACKGROUND

1. Field

Embodiments described herein relate generally to an inspecting apparatus of a semiconductor device and an inspection method.

2. Background Art

An inspecting apparatus of a semiconductor device according to the conventional art adjusts the focusing position of an optical system to be matched with the positions of upper portions of bumps normally formed on a surface of a wafer. A defective bump is detected on the basis of the difference obtained by pattern matching of acquired images of the bumps and previously registered reference images.

As such, when the optical system of which the focusing position is matched with the upper positions of the normal bumps is used to detect the defect of the wafer, the optical system is not focused on the surface of the wafer. For this reason, the difference between an image of the surface of the wafer acquired using the optical system and a previously registered reference image of the surface of the wafer becomes unclear. As a result, the precision of detecting the defect of the surface of the wafer is deteriorated. In order to maintain high precision of detecting the surface of the wafer, the optical system needs to focus on the surface of the wafer and obtain an image of the surface of the wafer again. Therefore, the throughput of the inspection is lowered.

### BRIEF DESCRIPTION OF THE DRAWINGS

FIG. 1 shows an example of the configuration of an inspecting apparatus 100 according to the first embodiment;

FIG. 2 shows an example of the concept of pattern matching by the inspecting apparatus 100 shown in FIG. 1;

FIG. 3 shows an example of a state where the inspection device 100 shown in FIG. 1 inspects the surface of the wafer and inspects the bump;

FIG. 4 shows an example of a flow of an inspection method using the inspection device 100 shown in FIG. 1; and

FIG. 5 shows an example of the configuration of an inspecting apparatus 200 according to the second embodiment.

### DETAILED DESCRIPTION

An inspecting apparatus of a semiconductor device according to an embodiment, includes an inspection stage that loads a wafer to be inspected thereon, and sets the position of the wafer. The inspecting apparatus includes a stage control unit that controls an operation of the inspection stage, such that a predetermined inspection position of the wafer can be inspected. The inspecting apparatus includes an illumination light source that emits illumination light. The inspecting apparatus includes a microscope that has an optical system focusing on the surface of the wafer, when the wafer is being inspected, that illuminates the wafer with the illumination light emitted from the illumination light source, and that forms and outputs a reflected light from the wafer. The inspecting apparatus includes a first light receiving sensor that senses an image of a surface of the wafer incident from the microscope, and that acquires first inspection image data of the surface of the wafer. The inspecting apparatus includes a second light receiving sensor that corrects a focusing position to focus on a reference position of an upper portion of a bump formed on the surface of the wafer, with respect to an image incident from the microscope, that senses an image of the bump incident from the microscope, and that acquires second inspection image data of the bump. The inspecting apparatus includes a first image processing unit that compares the first inspection image data acquired by the first light receiving sensor with previously acquired first reference image data, and that detects a defect of the surface of the wafer on the basis of the comparison result. The inspecting apparatus includes a second image processing unit that compares the second inspection image data acquired by the second light receiving sensor with previously acquired second reference image data, and that detects a defect of the bump on the basis of the comparison result.

Hereafter, embodiments will be described more specifically with reference to the drawings.

### First Embodiment

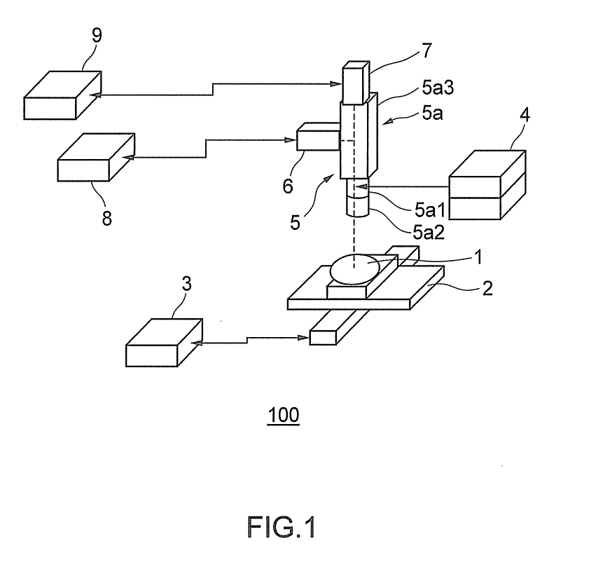

FIG. 1 shows an example of the configuration of an inspecting apparatus 100 according to the first embodiment. FIG.

2 shows an example of the concept of pattern matching by the inspecting apparatus 100 shown in FIG. 1.

As shown in FIG. 1, the inspecting apparatus 100 includes an inspection stage 2, a stage control unit 3, an illumination light source 4, a microscope 5, a first light receiving sensor 6, a second light receiving sensor 7, a first image processing unit 8, and a second image processing unit 9.

The inspection stage 2 loads a wafer 1 to be inspected thereon, moves the wafer 1 in a horizontal direction and a vertical direction, and sets the position of the wafer 1. The inspection stage 2 moves the wafer 1, and vacuum-sucks the wafer 1 to execute planarization and, at the same time, to prevent the deviation when moving the stage.

The stage control unit 3 controls an operation of the inspection stage 2, such that the predetermined inspection position of the wafer 1 can be inspected. The stage control unit 3 controls the inspection stage 2, such that the optical system 5a focuses on about the surface of the wafer 1 (the depth of focus is located on the surface of the wafer 1), when the wafer 1 is aligned after being mounted on the inspection stage 2. The stage control unit 3 outputs position information of the wafer 1 to the first and second image processing units 8 and 9.

The illumination light source 4 emits illumination light. For the illumination light source 4, for example, a laser light source is used. The wavelength of the illumination light is set according to an object to be inspected.

The microscope 5 illuminates the wafer 1 with the illumination light emitted from the illumination light source 4 and outputs reflected light from the wafer 1.

The microscope 5 has the optical system 5a. The optical system 5a includes a beam splitter 5a1, an object lens 5a2, and a body 5a3 that mounts an imaging lens and a dividing device thereon. The optical system 5a focuses on the surface of the wafer 1, when the wafer 1 is aligned after being mounted on the inspection stage 2. Therefore, the optical system 5a focuses on the surface of the wafer 1, when the wafer 1 is being inspected.

The dividing device of the body 5a3 divides the reflected light from the wafer 1 into reflected light for the first light receiving sensor 6 and reflected light for the second light receiving sensor 7. For example, the dividing device is a prism.

Onto the beam splitter 5a1, the illumination light that is emitted from the illumination light source 4 is incident. The beam splitter 5a1 reflects illumination light (S polarized light). The illumination light (S polarized light) is incident onto the object lens 5a2 through a λ/4 plate (not shown in the drawings). Meanwhile, the beam splitter 5a1 transmits reflected light (P polarized light) that is incident from the object lens 5a2 through the λ/4 plate. The reflected light (P polarized light) is incident onto the imaging lens of the body 5a3. The two imaging lenses are provided to correspond to the two beams of reflected light divided by the dividing device.

The object lens 5a2 illuminates (concentrates) the wafer 1 with the illumination light that has passed through the beam splitter 5a1 and emits the reflected light from the wafer 1 to the beam splitter 5a1.

The imaging lens of the body 5a3 emits the reflected light that has passed through the beam splitter 5a to the first and second light receiving sensors 6 and 7 to form an image.

The first light receiving sensor 6 senses the image of the surface of the wafer 1 that is incident from the microscope 5 and is formed, and acquires first inspection image data of the surface of the wafer 1. In this way, the image of the surface of the wafer 1 that is acquired using the optical system 5 focusing on the surface of the wafer 1 becomes clear.

Meanwhile, the second light receiving sensor 7 corrects the focusing position to focus on the reference position of the upper portion of the bump formed on the surface of the wafer 1 (the position of the upper portion of the bump that is normally formed), with respect to the image incident from the microscope 5. The second light receiving sensor 7 senses the image of the bump that is incident from the microscope 5 and acquires second inspection image data of the bump. In this way, the second light receiving sensor 7 acquires an inspection image that is formed by focusing on the bump.

Each of the first light receiving sensor 6 and the second light receiving sensor 7 is, for example, a CCD camera.

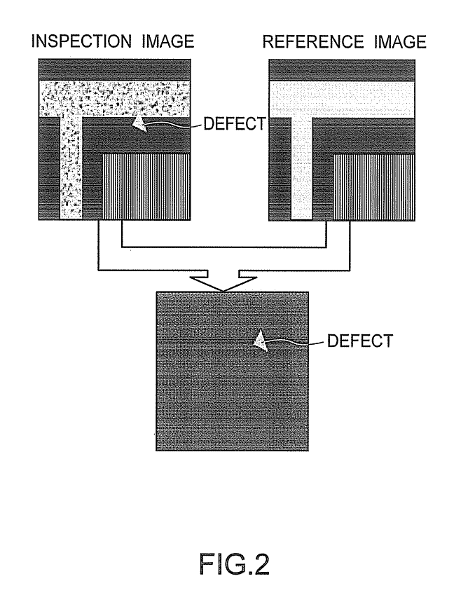

The first image processing unit 8 compares the first inspection image data acquired by the first light receiving sensor 6 with previously acquired (registered) first reference image data according to information input by a user and a registered recipe, and detects a defect of the surface of the wafer 1 on the basis of the comparison result (refer to FIG. 2).

In this case, the first reference image is an image of the surface of the wafer 1 at the predetermined inspection position where the defect does not exist.

That is, the first image processing unit 8 compares an image pattern (wiring pattern of an object to be inspected) according to the first inspection image data with an image pattern (normal wiring pattern) according to the first reference image data, and detects the defect of the surface of the wafer 1 on the basis of the difference in size between the portions different from each other or in color tone between the portions different from each other.

For example, when the difference in size or color tone between the different portions of the image pattern according to the first inspection image data and the image pattern according to the first reference image data is equal to or greater than a predetermined value, the first image processing unit 8 determines that the defect exists on the surface of the wafer 1.

The first image processing unit 8 recognizes whether the first inspection image data corresponds to the surface of the wafer 1, on the basis of the position information of the wafer 1 from the stage control unit 3, and determines whether the first inspection image data is set as an object to be compared. When it is determined that the first inspection image data corresponds to the surface of the wafer 1, the first image processing unit 8 sets the first inspection image data as the object to be compared.

The second image processing unit 9 compares the second inspection image data acquired by the second light receiving sensor 7 with previously acquired (registered) second reference image data according to the information input by the user and the registered recipe, and detects a defect of the bump on the basis of the comparison result.

In this case, the second reference image is an image including the bump that is normally formed at the predetermined inspection position. The principle of the pattern matching of the first image processing unit 8 and the second image processing unit 9 is the same.

That is, the second image processing unit 9 compares an image pattern (pattern of the bump to be inspected) according to the second inspection image data with an image pattern (pattern of the normal bump) according to the second reference image data, and detects the defect of the bump on the basis of the difference in size between the different portions or color tone between the different portions.

For example, when the difference in size or color tone between the different portions of the image pattern according to the second inspection image data and the image pattern according to the second reference image data is equal to or more than a predetermined value, the second image processing unit 9 determines that the bump is defective.

Examples of the defect of the bump include a defect where a solder ball portion of the bump does not exist, a defect where the solder ball portion and a connection electrode portion of the bump do not exist, a defect where the height of the solder ball of the bump is not the predetermined height, and a defect where the solder ball of the bump is excessively big.

The second image processing unit 9 recognizes whether the second inspection image data corresponds to the bump, on the basis of the position information of the wafer 1 sent from the stage control unit 3, and determines whether the second inspection image data is set as an object to be compared. When it is determined that the second inspection image data corresponds to the bump, the second image processing unit 9 sets the second inspection image data as the object to be compared.

The detection of the defect of the surface of the wafer 1 using the first image processing unit 8 and the detection of the defect of the bump using the second image processing unit 9 are concurrently executed. Thereby, the throughput of the inspection can be improved.

As described above, the first and second image processing units 8 and 9 can acquire the images that are formed by focusing on the surface and the bump of the wafer 1, respectively. That is, the inspection device 100 can improve the precision of detecting the defect of the surface of the wafer 1 and the precision of detecting the defect of the bump.

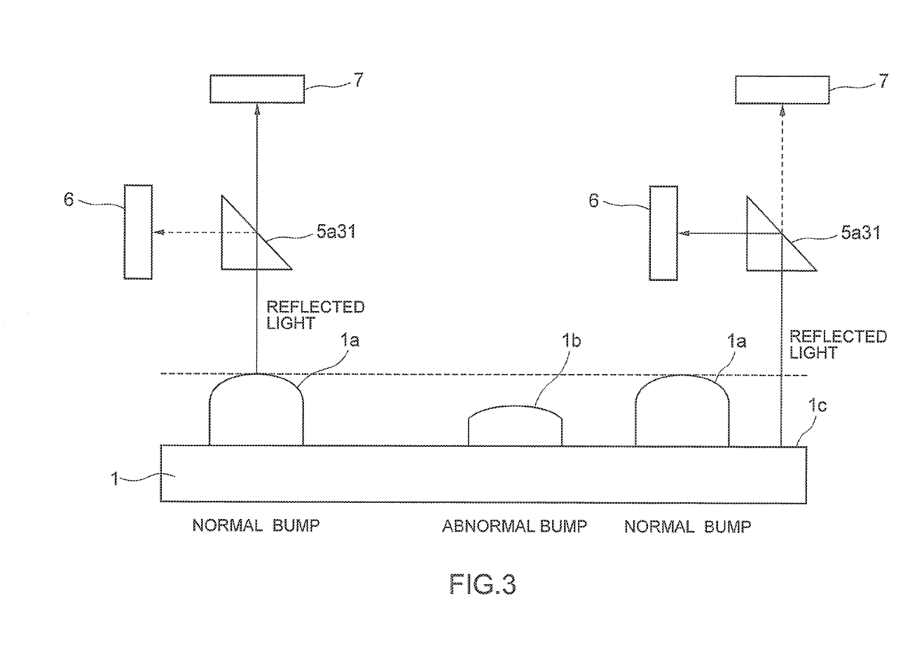

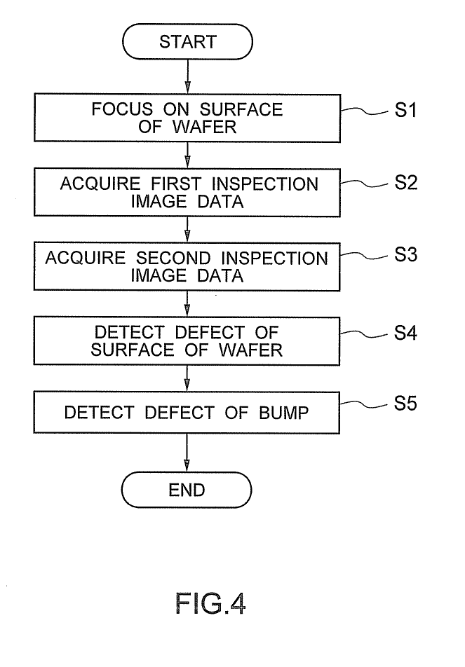

In this case, an example of the operation of when the inspection device 100 having the above configuration concurrently inspects the defect of the surface of the wafer and the defect of the bump formed on the surface of the wafer will be described. FIG. 3 shows an example of a state where the inspection device 100 shown in FIG. 1 inspects the surface of the wafer and inspects the bump. FIG. 4 shows an example of a flow of an inspection method using the inspection device 100 shown in FIG. 1.

In FIG. 3, only the first and second light receiving sensors 6 and 7, and a dividing device (prism) 5a31 among the components of the inspection device 100 are shown to simplify the description.

First, when the wafer 1 is being inspected, the optical system 5a of the microscope 5 focuses on a surface 1c of the wafer 1, the wafer 1 is illuminated with the illumination light emitted from the illumination light source 4, and the reflected light from the wafer 1 is output (step S1 of FIG. 4).

Next, as shown at the right side of FIG. 3, the wafer 1 is moved (scanned) such that at least the surface 1c of the wafer 1 at the predetermined position is illuminated with the illumination light. The first light receiving sensor 6 senses the image of the surface of the wafer 1 that is incident from the microscope 5 and is formed (divided by the dividing device 5a31), and acquires the first inspection image data of the surface of the wafer 1 (step S2 of FIG. 4).

Next, as shown at the left side of FIG. 3, the wafer 1 is moved (scanned) such that at least a bump 1a at the predetermined position is illuminated with the illumination light. The second light receiving sensor 7 previously corrects the focusing position with the reference position of the upper portion of the bump is formed on the surface of the wafer 1, with respect to the image incident from the microscope 5. The second light receiving sensor 7 senses the image of the bump 1a that is incident from the microscope 5 (divided by the dividing device 5a31), and acquires the second inspection image data of the bump is (step S3 of FIG. 4).

The first image processing unit 8 compares the first inspection image data acquired by the first light receiving sensor 6 with the previously acquired first reference image data, and detects the defect of the surface of the wafer 1 on the basis of the comparison result (step S4 of FIG. 4).

The second image processing unit 9 compares the second inspection image data acquired by the second light receiving sensor 7 with the previously acquired second reference image data, and detects the defect of the bump la on the basis of the comparison result (step S5 of FIG. 4). In the example of FIG. 3, since the normal bump is having the normal height is inspected, the second image processing unit 9 determines that the bump la is not defective, by performing the pattern matching. Meanwhile, when an abnormal bump 1b shown in FIG. 3 is inspected, the second image processing unit 9 determines that the bump 1b is defective, by performing the pattern matching.

By the above steps, the wafer 1 is inspected by the inspection device 100. As described above, the focusing position of the optical system 5a is not changed between the inspection of the defect of the surface of the wafer 1 and the inspection of the defect of the bump. Therefore, the throughput of the inspection of the wafer 1 can be improved.

The step S2 and the step S3 may be reversely executed according to the inspection order at the time of inspecting the wafer 1. The step S4 and the step S5 may be reversely executed and may be simultaneously (concurrently) executed.

As such, according to the inspection device according to the first embodiment, the throughput of the inspection can be improved.

### Second Embodiment

In the first embodiment described above, the example of the configuration of the inspection device 100 that inspects the defect of the surface of the wafer and the defect of the bump formed on the surface of the wafer is described.

In this case, even when the inspection device includes two microscopes for inspection of the surface of the wafer 1 and inspection of the bump, the throughput of the inspection can be improved.

Therefore, in the second embodiment, an example of the configuration of the inspection device that includes the two microscopes for inspection of the surface of the wafer 1 and inspection of the bump will be described. In the second embodiment, the dividing device of the microscope that is described in the first embodiment is not needed.

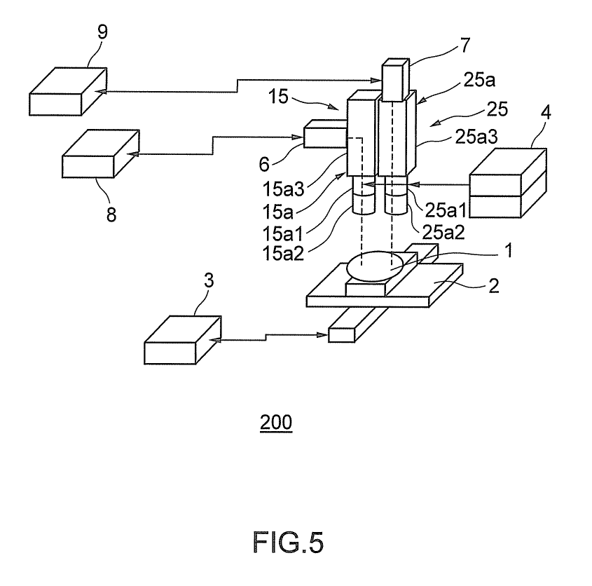

FIG. 5 shows an example of the configuration of an inspecting apparatus 200 according to the second embodiment. In FIG. 5, the same reference numerals as those of FIG. 1 denote the same components as those of FIG. 1.

As shown in FIG. 5, the inspecting apparatus 200 includes an inspection stage 2, a stage control unit 3, an illumination light source 4, a first microscope 15, a second microscope 25, a first light receiving sensor 6, a second light receiving sensor 7, a first image processing unit 8, and a second image processing unit 9.

The first microscope 15 illuminates the wafer 1 with illumination light emitted from the illumination light source 4 and outputs reflected light from the wafer 1.

The first microscope 15 has a first optical system 15a. The first optical system 15a includes a beam splitter 15a1, an object lens 15a2, and a body 15a3 that mounts an imaging lens thereon. The first optical system 15a focuses on the surface of the wafer 1, when the wafer 1 is aligned after being mounted on the inspection stage 2. Therefore, the first optical system 15a focuses on the surface of the wafer 1, when the wafer 1 is being inspected.

Onto the beam splitter 15a1, illumination light that is emitted from the illumination light source 4 is incident. The beam splitter 15a1 reflects illumination light (S polarized light). The illumination light (S polarized light) is incident onto the object lens 15a2 through a λ/4 plate (not shown in the drawings). Meanwhile, the beam splitter 15a1 transmits reflected light (P polarized light) that is incident from the object lens 15a2 through the λ/4 plate. The reflected light (P polarized light) is incident onto the imaging lens of the body 5a3.

The object lens 15a2 illuminates (concentrates) the wafer 1 with the illumination light that has passed through the beam splitter 15a1 and emits the reflected light from the wafer 1 to the beam splitter 15a1.

The imaging lens of the body 15a3 emits the reflected light that has passed through the beam splitter 15a to the first light receiving sensor 6 to form an image.

The second microscope 25 illuminates the wafer 1 with the illumination light emitted from the illumination light source 4 and outputs the reflected light from the wafer 1.

The second microscope 25 has a second optical system 25a. The second optical system 25a includes a beam splitter 25a1, an object lens 25a2, and a body 25a3 that mounts an imaging lens thereon. The second optical system 25a focuses on the reference position of the upper portion of the bump, when the wafer 1 is aligned after being mounted on the inspection stage 2. Therefore, the second optical system 25a focuses on the reference position of the upper portion of the bump, when the wafer 1 is being inspected.

Onto the beam splitter 25a1, illumination light that is emitted from the illumination light source 4 is incident. The beam splitter 25a1 reflects the illumination light (S polarized light). The illumination light (S polarized light) is incident on the object lens 25a2 through a λ/4 plate (not shown in the drawings). Meanwhile, the beam splitter 25a1 transmits reflected light (P polarized light) that is incident from the object lens 25a2 through the λ/4 plate. The reflected light (P polarized light) is incident on the imaging lens of the body 25a3.

The object lens 25a2 illuminates (concentrates) the wafer 1 with the illumination light that has passed through the beam splitter 25a1 and emits the reflected light from the wafer 1 to the beam splitter 25a1.

The imaging lens of the body 25a3 emits the reflected light that has passed through the beam splitter 25a to the second light receiving sensor 7 to form an image.

In this case, the first light receiving sensor 6 senses the image of the surface of the wafer 1 that is incident from the first microscope 15 and is formed, and acquires first inspection image data of the surface of the wafer 1. In this way, the image on the surface of the wafer 1 that is acquired using the optical system 5 focusing on the surface of the wafer 1 becomes clear.

Meanwhile, the second light receiving sensor 7 senses the image of the bump that is incident from the second microscope 25 and is formed, and acquires second inspection image data of the bump. In this way, the second light receiving sensor 7 acquires an inspection image that is formed by focusing on the bump.

The other configurations of the inspection device 200 according to the second embodiment are the same as those of the inspection device 100 according to the first embodiment.

In this case, the operation of when the inspection device 200 having the above configuration concurrently inspects the defect of the surface of the wafer and the defect of the bump formed on the surface of the wafer is similar to the operation in the first embodiment. Therefore, the operation will be described using FIG. 4 described above.

First, when the wafer 1 is being inspected, the optical system 15a of the microscope 15 focuses on a surface is of the wafer 1, the wafer 1 is illuminated with the illumination light emitted from the illumination light source 4, and the reflected light from the wafer 1 is output (step S1 of FIG. 4). At this time, in the second embodiment, the second optical system 25a of the second microscope 25 focuses on the reference position of the upper portion of the bump, the wafer 1 is illuminated with the illumination light emitted from the illumination light source 4, and the reflected light from the wafer 1 is output.

Next, the wafer 1 is moved (scanned) such that at least the surface 1c of the wafer 1 at the predetermined inspection position is illuminated with the illumination light. The first light receiving sensor 6 senses the image of the surface of the wafer 1 that is incident from the first microscope 15 and is formed, and acquires the first inspection image data of the surface of the wafer 1 (step S2 of FIG. 4).

Next, the wafer 1 is moved (scanned) such that at least the bump is at the predetermined inspection position is illuminated with the illumination light. The second light receiving sensor 7 senses the image of the bump 1a that is incident from the second microscope 25 and acquires the second inspection image data of the bump is (step S3 of FIG. 4).

Similar to the first embodiment, the first image processing unit 8 compares the first inspection image data acquired by the first light receiving sensor 6 with the previously acquired first reference image data, and detects the defect of the surface of the wafer 1 on the basis of the comparison result (step S4 of FIG. 4).

Similar to the first embodiment, the second image processing unit 9 compares the second inspection image data acquired by the second light receiving sensor 7 with the previously acquired second reference image data, and detects the defect of the bump 1a on the basis of the comparison result (step S5 of FIG. 4).

By the above steps, the wafer 1 is inspected by the inspection device 200. As described above, the focusing position of the optical systems 15a and 25a is not changed between the inspection of the defect of the surface of the wafer 1 and the inspection of the defect of the bump. Therefore, the throughput of the inspection of the wafer 1 can be improved.

The step S2 and the step S3 may be reversely executed according to the inspection order at the time of inspecting the wafer 1. The step S4 and the step S5 may be reversely executed and may be simultaneously (concurrently) executed.

As such, according to the inspection device according to the second embodiment, the throughput of the inspection can be improved, similar to the first embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An inspecting apparatus of a semiconductor device comprising:
an inspection stage that loads a wafer to be inspected thereon, and sets the position of the wafer;
a stage control unit that controls an operation of the inspection stage, such that a predetermined inspection position of the wafer can be inspected;
an illumination light source that emits illumination light;
a microscope that has an optical system focusing on the surface of the wafer, when the wafer is being inspected, that illuminates the wafer with the illumination light emitted from the illumination light source, and that forms and outputs a reflected light from the wafer;
a first light receiving sensor that senses an image of a surface of the wafer incident from the microscope, and that acquires first inspection image data of the surface of the wafer;
a second light receiving sensor that corrects a focusing position to focus on a reference position of an upper portion of a bump formed on the surface of the wafer, with respect to an image incident from the microscope, that senses an image of the bump incident from the microscope, and that acquires second inspection image data of the bump;
a first image processing unit that compares the first inspection image data acquired by the first light receiving sensor with previously acquired first reference image data, and that detects a defect of the surface of the wafer on the basis of the comparison result; and
a second image processing unit that compares the second inspection image data acquired by the second light receiving sensor with previously acquired second reference image data, and that detects a defect of the bump on the basis of the comparison result.

2. The inspecting apparatus according to claim 1, wherein the first light receiving sensor and the second light receiving sensor are CCD cameras.

3. The inspecting apparatus according to claim 1, wherein the first reference image is an image of the surface of the wafer at the predetermined inspection position where a defect does not exist.

4. The inspecting apparatus according to claim 1, wherein the second reference image is an image including a bump that is normally formed at the predetermined inspection position.

5. The inspecting apparatus according to claim 1, wherein an optical system of the microscope has a dividing device, the dividing device dividing the reflected light from the wafer into reflected light for the first light receiving sensor and reflected light for the second light receiving sensor.

6. The inspecting apparatus according to claim 5, wherein the dividing device is a prism.

7. The inspecting apparatus according to claim 1, wherein an optical system of the microscope comprises:
a beam splitter that is entered the illumination light emitted from the illumination light source;
an object lens that illuminates the wafer with the illumination light passed through the beam splitter, and that emits the reflected light from the wafer to the beam splitter; and
an imaging lens that emits the reflected light passed through the beam splitter to form an image.

8. The inspecting apparatus according to claim 1, wherein the first image processing unit compares an image pattern according to the first inspection image data with an image pattern according to the first reference image data, and detects the defect of the surface of the wafer on the basis of a difference in size between portions different from each other or in color tone between portions different from each other.

9. The inspecting apparatus according to claim 1, wherein the second image processing unit compares an image pattern according to the second inspection image data with an image pattern according to the second reference image data, and detects the defect of the bump on the basis of a difference in size between portions different from each other or color tone between portions different from each other.

10. The inspecting apparatus according to claim 1, wherein a detection of the defect of the surface of the wafer using the first image processing unit and a detection of the defect of the bump using the second image processing unit are concurrently executed.

11. An inspecting apparatus of a semiconductor device comprising:
an inspection stage that loads a wafer to be inspected thereon, and sets the position of the wafer;
a stage control unit that controls an operation of the inspection stage, such that a predetermined inspection position of the wafer can be inspected;
an illumination light source that emits illumination light;
a first microscope that has an first optical system focusing on the surface of the wafer, when the wafer is being inspected, that illuminates the wafer with the illumination light emitted from the illumination light source, that forms and outputs a reflected light from the wafer;
a second microscope that has an second optical system focusing on a bump on the surface of the wafer, when the wafer is being inspected, that illuminates the wafer with the illumination light emitted from the illumination light source, and that forms and outputs a reflected light from the wafer;
a first light receiving sensor that senses an image of a surface of the wafer incident from the first microscope, and that acquires first inspection image data of the surface of the wafer;
a second light receiving sensor that senses an image of the bump incident from the second microscope, and that acquires second inspection image data of the bump;
a first image processing unit that compares the first inspection image data acquired by the first light receiving sensor with previously acquired first reference image data, and that detects a defect of the surface of the wafer on the basis of the comparison result; and
a second image processing unit that compares the second inspection image data acquired by the second light receiving sensor with previously acquired second reference image data, and that detects a defect of the bump on the basis of the comparison result.

12. The inspecting apparatus according to claim 11, wherein the first light receiving sensor and the second light receiving sensor are CCD cameras.

13. The inspecting apparatus according to claim 11, wherein the first reference image is an image of the surface of the wafer at the predetermined inspection position where a defect does not exist.

14. The inspecting apparatus according to claim 11, wherein the second reference image is an image including a bump that is normally formed at the predetermined inspection position.

15. The inspecting apparatus according to claim 11, wherein the first image processing unit compares an image pattern according to the first inspection image data with an image pattern according to the first reference image data, and detects the defect of the surface of the wafer on the basis of a difference in size between portions different from each other or in color tone between portions different from each other.

16. The inspecting apparatus according to claim 11, wherein the second image processing unit compares an image pattern according to the second inspection image data with an image pattern according to the second reference image data, and detects the defect of the bump on the basis of a difference in size between portions different from each other or color tone between portions different from each other.

17. The inspecting apparatus according to claim 11, wherein a detection of the defect of the surface of the wafer using the first image processing unit and a detection of the defect of the bump using the second image processing unit are concurrently executed.

18. An inspection method that detects a defect of a surface of a wafer and a defect of the bump on the surface of the wafer, the inspection method comprising:
focusing an optical system on the surface of the wafer, when the wafer is being inspected, illuminating the wafer with the illumination light emitted from the illumination light source, and forming and outputting a reflected light from the wafer;
sensing an image of a surface of the wafer incident from the microscope by a first light receiving sensor to acquire first inspection image data of the surface of the wafer;
correcting a focusing position to focus on a reference position of an upper portion of a bump formed on the surface of the wafer, with respect to an image incident from the microscope, and sensing an image of the bump incident from the microscope by a second light receiving sensor to acquire second inspection image data of the bump;
comparing the first inspection image data acquired by the first light receiving sensor with previously acquired first reference image data by a first image processing unit to detect a defect of the surface of the wafer on the basis of the comparison result; and
comparing the second inspection image data acquired by the second light receiving sensor with previously acquired second reference image data by a second image processing unit to detect a defect of the bump on the basis of the comparison result.

19. The inspection method according to claim 18, wherein the first reference image is an image of the surface of the wafer at the predetermined inspection position where a defect does not exist.

20. The inspection method according to claim 18, wherein the second reference image is an image including a bump that is normally formed at the predetermined inspection position.
